(19) United States
(12) Patent Application Publication
(10) Pub. No.: US 2023/0298417 A1
(43) Pub. Date: Sep. 21, 2023

(54) USING IDENTITY CREDENTIALS AS A KEY FOR SECURELY CONTROLLING A LOCK CONNECTED TO A WIRELESS NETWORK

(71) Applicant: CAPITAL ONE SERVICES,LLC, McLean, VA (US)

(72) Inventors: Kevin Osborn, Newton, MA (US); Jeffrey Rule, Chevy Chase, MD (US)

(73) Assignee: CAPITAL ONE SERVICES, LLC, McLean, VA (US)

(21) Appl. No.: 17/696,034

(22) Filed: Mar. 16, 2022

(51) Int. Cl. G07C 9/23; G07C 9/27; G07C 9/00; H04L 9/40

(52) U.S. Cl. CPC G07C 9/23; G07C 9/27; G07C 9/00309; G07C 9/00904; H04L 63/0492; G07C 2009/00412; G07C 2009/00769

(57) ABSTRACT

Locks may rely upon identity credentials to act as keys for unlocking and/or locking the locks, such as door locks. The identity credentials may be digital credentials that hold identity information and evidence of knowledge of secret information, such as a password or a private cryptographic key. The door locks in exemplary embodiments may be connected to an access system via wireless network, such as a low power low frequency Wi-Fi network, like a HaLow network. The wireless network enables the door locks to communicate with the access system, such as a server for a lodging establishment. The access system may receive identity credentials and forward the identity credentials to an authentication service for authentication. The access system may also pass the identity of the guest to an authorization service to determine if the guest is authorized to unlock the door lock or not.

### BACKGROUND

Lodging establishments, such as hotels and motels, formerly provided guests with metal keys. Unfortunately, such metal keys were susceptible to being lost, stolen, or not returned to the lodging establishments. Such metal keys that were lost, stolen, or not returned had to be replaced at the lodging establishments' expense. In addition, the lost, stolen, and not returned keys posed a security risk in that such metal keys could still be used to gain access to guest rooms. Some lodging establishments would replace their locks periodically at great expense to reduce the risk of misuse of such lost, stolen, and not returned metal keys.

Due to these drawbacks of metal keys, plastic programmable keys have been widely adopted by lodging establishments. The plastic programmable keys have a magnetic strip or a radio-frequency identification (RFID) tag that encodes information that may be read by a door lock to unlock the door. The encoded information typically includes a room number and a start time and an end time for which the key is valid. In some instances, the encoded information includes a guest number as well.

There are also drawbacks to programmable plastic keys. Such plastic programmable keys are lost frequently and require replacement. The cost of replacing such plastic programmable keys over time may be substantial for lodging establishments. In addition, the plastic programmable keys may pose a security risk. Any party that is in possession of a plastic programmable key who knows what room is associated with the plastic programmable key may gain access to the room with the key. Thus, stolen, lost, and not returned keys may be problematic if they fall into the wrong hands.

### SUMMARY

In accordance with a first aspect, a method may be performed by a processor of a computing device. The method may include receiving, from a door lock and over a wireless network, a secure package comprising a cryptographic payload, the cryptographic payload generated by a contactless card based at least in part on a cryptographic key for the contactless card. The method may further include transmitting the cryptographic payload to an authentication service for authentication based at least in part on an instance of the cryptographic key for the contactless card maintained by the authentication service. The method may further comprise receiving a response from the authentication service indicating that the cryptographic payload was authenticated based at least in part on the instance of the cryptographic key for the contactless card maintained by the authentication service. The method may further comprise determining, based on access information, that a user associated with the contactless card is authorized to unlock the door, and sending a communication over the wireless network to the door lock to cause the door lock to unlock.

The cryptographic payload may be encrypted. The door lock may be for a door of a guest quarters in a lodging establishment. The authentication service may be located remotely at a different street address from the door lock. The authentication service may be a cloud service. The wireless network may be a Wi-Fi® network.

In accordance with another aspect, a method may be performed by a processor of a mobile computing device. In the method, the processor may wirelessly connect with a door lock. A message may be generated that includes a cryptographic payload for a user that wishes to unlock the door lock and the generated message may be wirelessly sent to the door lock to unlock the door.

The wirelessly connecting with the door lock may include using near field communication (NFC) to wirelessly communicate with the door lock. The mobile computing device may be one of a smartphone, a smartwatch, a tablet computer, or another type of wearable computing device. The cryptographic payload may be encrypted. The cryptographic payload may include a one-time password. The cryptographic payload may be received from a contactless card.

In accordance with an additional aspect, method may be performed by processing logic of a door lock that is connected to a wireless network. The method may include receiving, from a contactless card, a secure package comprising a cryptographic payload, the cryptographic payload generated based at least in part on a cryptographic key for the contactless card. The method may further include transmitting, via a wireless network, the cryptographic payload to an authentication service for authentication based at least in part on an instance of the cryptographic key for the contactless card maintained by the authentication service. The method may further include receiving a response from the authentication service indicating that the cryptographic payload was authenticated based at least in part on the instance of the cryptographic key for the contactless card maintained by the authentication service. The method may further include sending a communication to an authorization service to determine whether a user associated with the contactless card is authorized to unlock the door lock, and receiving, from the authorization service, an indication specifying that the user associated with the contactless card is authorized to unlock the door lock. The method may further include unlocking the door lock based on the responses received from the authentication service and the authorization service.

### BRIEF DESCRIPTION OF THE DRAWINGS

FIG. 1 depicts a computing environment suitable for exemplary embodiments.

FIG. 2A depicts components of a mobile computing device in an exemplary embodiment.

FIG. 2B depicts a several varieties of mobile computing devices that may be used in exemplary embodiments.

FIG. 3 depicts an illustrative door lock suitable for exemplary embodiments.

FIG. 4 depicts illustrative components of an access system that is suitable for exemplary embodiments.

FIG. 5 depicts a flowchart of illustrative steps that may be performed in exemplary embodiments to unlock a door lock.

FIG. 6A depicts a flowchart of illustrative steps that may be performed in exemplary embodiments for a user to input identity credentials using a contactless card.

FIG. 6B depicts an illustrative interaction that may be performed between a contactless card and a mobile computing device to forward a secure package in an exemplary embodiment.

FIG. 7A depicts an illustrative hash operation that may be performed in exemplary embodiments to generate a hash value that may be used in generating identity credentials.

FIG. 7B depicts examples of input that may be fed into a hash function as part of a hash operation.

FIG. 8A depicts the front face of an illustrative contactless card that may be suitable for use in exemplary embodiments.

FIG. 8B depicts hardware components of an illustrative contactless card.

FIG. 8C depicts a flowchart of illustrative steps that may be performed in exemplary embodiments in authenticating identity credentials originating with a contactless card.

FIG. 9 depicts a flowchart of illustrative steps that may be performed in exemplary embodiments where a user provides identity credentials using a cryptographic key.

FIG. 10 depicts a flowchart of illustrative steps that may be performed in exemplary embodiments to authenticate identity credentials when a cryptographic challenge is used.

FIG. 11A depicts a flowchart of illustrative steps that may be performed in exemplary embodiments by the authorization service in response to an authorization request.

FIG. 11B depicts a flowchart of illustrative steps that may be performed in exemplary embodiments to determine if a user is authorized to unlock a door lock of a guest room at a particular date and time.

### DETAILED DESCRIPTION

The exemplary embodiments may provide door locks and/or other locks that rely upon identity credentials to act as keys for unlocking and/or locking the locks. The identity credentials may be digital credentials that hold identity information and evidence of knowledge of secret information, such as a password or a private cryptographic key. The use of the identity credentials may enhance security by requiring possession of a touchless card, a private cryptographic key or other confidential information that is presumed to be known only by the party associated with a given identity. Parties other than the identified party may not possess such identity credentials and thus may not be able to use the key. This approach reduces the risk associated with conventional keys at lodging establishments where an unauthorized party may use the key to gain access to a guest's room.

The exemplary embodiments may not require a physical key. Thus, there is no physical key that may be lost or stolen. As such, lodging establishments may not need to continually replace physical keys at substantial expense. The identity credentials may be kept in or may be generated using a mobile computing device, such as a smartphone, smartwatch, a tablet computing device, a laptop computer, or the like. Moreover, such mobile computing devices may require a user to enter a username and password to gain access to software installed thereon. As such, the identity credentials may be more secure than conventional plastic programmable keys.

The locks in exemplary embodiments, such as door locks, may be connected to an access system via wireless network, such as a low power low frequency Wi-Fi network, such as a HaLow® network. The wireless network may enable the door locks to communicate with the access system, such as server for a lodging establishment. A HaLow network may facilitate direct connections between the door locks and the access systems. A HaLow network may directly connect the door locks and the access system separated by over 1 kilometer in distance. The use of a HaLow network may eliminate the need for a traditional Wi-Fi network to route the signal. As such, one may place the access system a kilometer away or may place the access system in a basement which may not need any other networking components. The use of the HaLow network may be especially beneficial for hotels. The HaLow network may enable the access system to be placed in storage buildings or other buildings that don't have existing Wi-Fi infrastructure.

As such, hotel clerks may unlock doors from their computer terminal rather than needing to be at the door to use a key. The access system may receive identity credentials and forward the identity credentials to an authentication service for authentication. The access system may also pass the identity of the guest to an authorization service to determine if the guest may be authorized to unlock the door lock or not. More generally, access control information may be stored for the guest by the authorization service where the access control information determines what areas the guest has access to, like a guest room, spa, fitness center, etc.

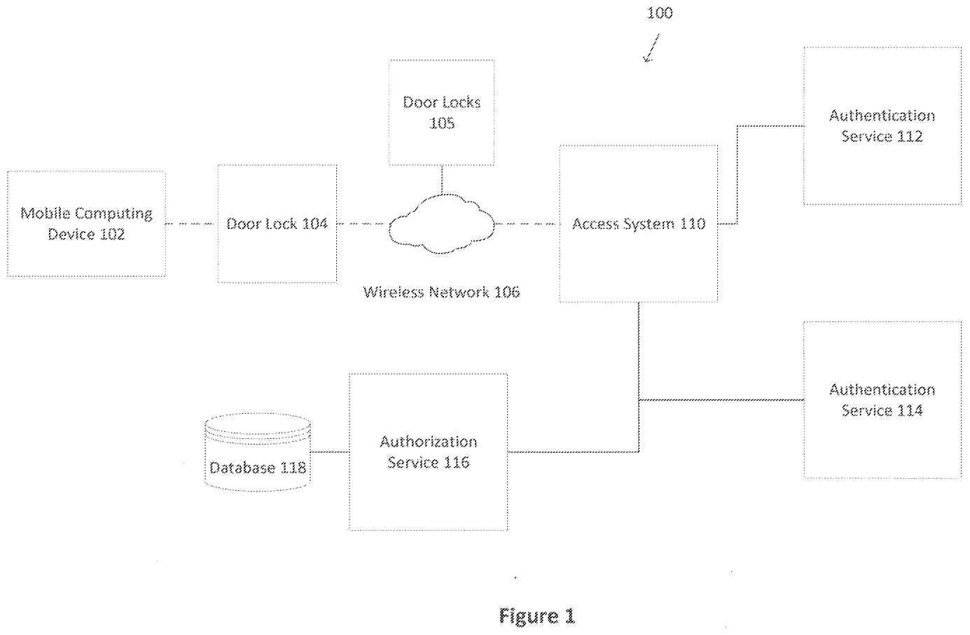

FIG. 1 depicts an illustrative computing environment 100 that may be suitable for exemplary embodiments. The computing environment 100 may include a mobile computing device 102 that may interact with a door lock 104. As will be discussed in more detail below, the mobile computing device 102 and the door lock 104 may wirelessly communicate with each other as indicated by the dotted line interconnecting the mobile computing device 102 and the door lock 104. The door lock 104 may be connected to a wireless network 106, such as a HaLow network (e.g., an Institute of Electrical and Electronics Engineers (IEEE) 802.11ah network). HaLow networks may require low power and may operate at low frequencies that may enable good penetration through walls and other structures relative to other wireless networks. In addition, HaLow networks may have good range relative to other wireless networks. Hence, HaLow networks may be good candidates for use in the embodiments described herein. Moreover, the HaLow networks may have the benefit that access systems may be positioned where there is no Wi-Fi infrastructure and may be positioned remotely from hotel rooms over one kilometer away.

An access system 110 may be connected to the wireless network 106 and may communicate with door lock 104 and other door locks 105 via the wireless network. The access system may be realized as a computing device, such as a server computer, that regulates access to the guest rooms via the door locks 104 and 105. Software for controlling the door locks may be stored and run on the access system 110. The access system 110 may be connected to one or more authentication services 112 and 114. The authentication services 112 and 114 may run on server computer systems, local computing devices, or a cloud services infrastructure. The access system 110 may connect with the authentication services over a network connection, such as over the Internet. The authentication services 112 and 114 may authenticate identity credentials of a user to authenticate the identity of the user and may be realized in software, hardware, or a combination thereof. The authentication services 112 and 114 may, in some exemplary embodiments, authenticate identity credentials originating at least in part from a touchless (or contactless) card, such as the Presto card from Capital One Financial Corporation. The authentication services 112 and 114 may in some exemplary embodiments authenticate identity credentials that may be provided via the Fast IDentity Online (FIDO®) Alliance FIDO2 authentication protocol, or from any another cryptographic identity authentication protocol.

The access system 110 may have a connection to access an authorization service 116. The connection may be a network connection, such as via a local rea network (LAN), a wide area network (WAN), or a combination thereof. The authorization service 116 may be realized in software running on a computing device. The authorization service 116 may receive requests for whether a party is authorized to interact with a door lock 104, such as whether the party is authorized to unlock the door lock 104 or not. The authorization service 116 may look up information in a database to determine whether the party is authorized or not authorized. For each guest, the database may hold, for example, information regarding what room the guest is in, what dates and times the guest has access to the room, and/or access control rights for the guest. The authorization service 116 may return the information from the database 118 to the access system 110 or may return an answer whether the guest is permitted to unlock the door lock or not permitted to unlock the door lock. Based on the information provided by the authentication services 112 and 114 and/or the authorization service 116, the access system 110 may decide whether to permit a user to unlock a door lock or not. As discussed below, the access system 110 may send messages, commands, or signals to the door lock 104 to unlock the door lock 104.

Although the discussion herein includes unlocking a door lock, because most door locks for lodging establishments default to a locked state when closed, it should be appreciated that the authorization may also be to lock a door lock or to both lock and unlock a door lock. The door lock may be for a guest room or may be for other portions of a lodging establishment, such as a fitness center, a business center, a pool, or the like. The lock may also be in an elevator to limit access to particular floors, such as floors that are part of a concierge level.

Moreover, the lock need not be a door lock in a lodging establishment but may be a door lock in other settings, such as in an office building, an office, a storage facility, a military base, a hospital, a prison, etc. Still further, the lock may not be a door lock, but rather may more generally be a lock that limits access to a space, enclosure, item, etc.

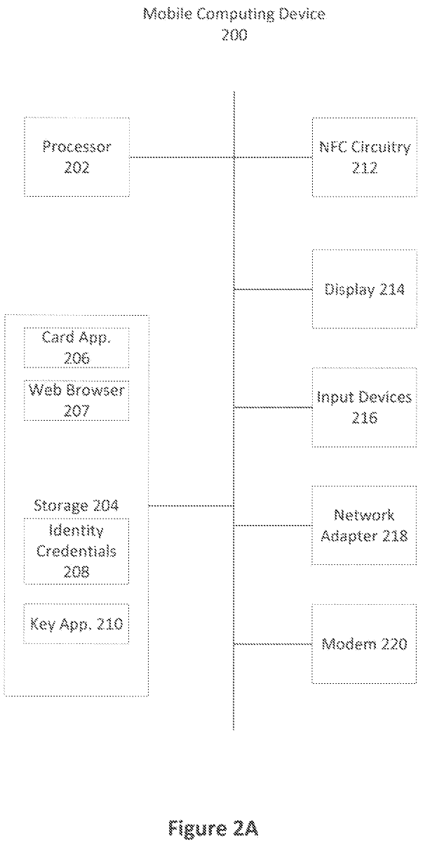

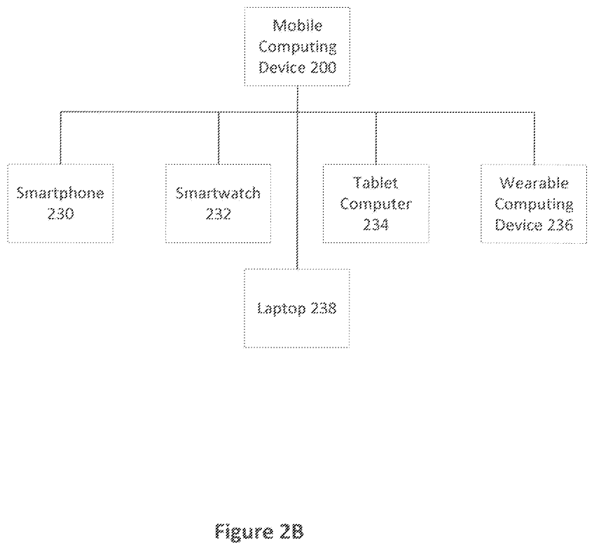

FIG. 2A depicts an example mobile computing device 200 that may be used by a user, such as a guest of a lodging establishment, to unlock a door lock for a guest room (or other doors, items, or areas in the lodging establishment). The mobile computing device 200 includes a processor 202. The processor 202 may be, for example, a microprocessor like a central processing unit (CPU) or a graphics processing unit (GPU), a logic circuit, a field programmable gate array (FPGA), an application specific integrated circuit (ASIC) or a microcontroller. The processor 202 may have access to a storage 204. The storage 204 may include both primary memory and secondary memory. The storage 204 may include random access memory (RAM), read only memory (ROM), optical storage, magnetic storage, removable storage media, solid state memory or the like. The storage 204 may include non-transitory computer-readable storage media. The storage 204 may include computer programming instructions, such as a card application 206. The card application 206 provides support for use of a contactless card, such as a smart card, like the Presto card from Capital One Financial Corporation. The storage 204 may also include a web browser 207 for browsing the Worldwide Web. The storage 204 additionally may include identity credentials 208 for the user. The storage 204 may hold a key application 210 that contains instructions for enabling the mobile computing device 200 to be used as a key that may wirelessly present a digital key to the door lock 104.

The mobile computing device 200 may include NFC circuitry for making the mobile computing device 200 NFC-capable. The NFC circuitry 212 may include, for example, an antenna, a wireless adapter, and a wireless transceiver. The mobile computing device 200 may include a display 214, such as a touchscreen display, a light-emitting diode (LED) display, or a liquid-crystal display (LCD), for displaying text, graphical content, or video content. The mobile computing device 200 may include input devices 216, like a touchscreen, depressible buttons, a thumbwheel, keys, a thumb pad, a mouse, etc. The mobile computing device 200 may include a network adapter 218 for interfacing with a network. The mobile computing device 200 may include a modem 220, such as a cellular modem.

The mobile computing device 200 may take many different forms, such as depicted in FIG. 2B. The mobile computing device 200 may be a smartphone 230 or a smartwatch 232. The mobile computing device 200 may be a laptop computing device 238 or a tablet computer 234. The mobile computing device 200 may be a wearable device 236. The depicted examples of types of mobile computing devices are intended to be illustrative and not limiting.

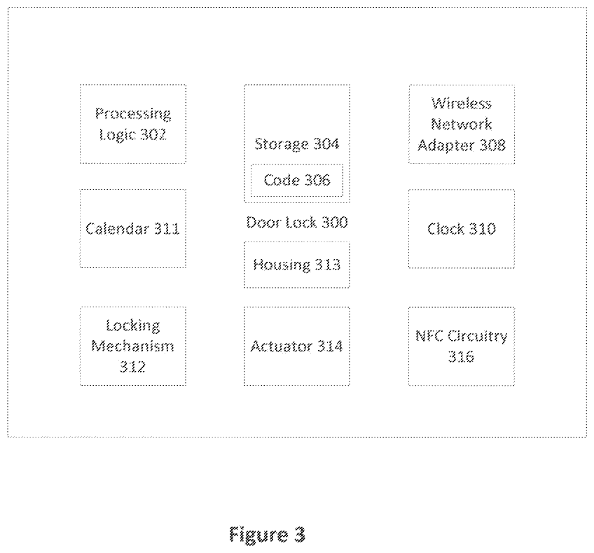

FIG. 3 depicts components of an illustrative door lock 300 that may be suitable for exemplary embodiments. The door lock 300 may include processing logic 302. The processing logic 302 may include a microprocessor, an FPGA, an ASIC, electrical circuitry, or the like for controlling operation of the door lock 300. The door lock may include storage 304, such as non-transitory computer-readable storage media, e.g., random access memory (RAM), read-only memory (ROM), solid state memory, optical storage media, magnetic storage media, or the like. The storage 304 may include primary memory and/or secondary memory as well as caches. The storage 304 may store computer programming code that may be executable by the processing logic 302 to control operation of the door lock 300. The door lock 300 may include a wireless network adapter 308 enabling the door lock 300 to connect to the wireless network 106. The door lock 300 may include an internal calendar 311 and a clock 310 for maintaining the current date and time. The door lock 300 may include a locking mechanism 312, such as a bolt that can move between a lock and an unlocked position, and an actuator 314 for actuating the locking mechanism 312. The actuator 314 may be a motor or other electrically driven actuator. The door lock 300 may include a housing 313 for encasing the internal components of the door lock 300. The housing 313 may be designed to be integrated with a door, and the locking mechanism 312 may be designed to interact with features, such as a striker plate on a door jamb of a door frame for the door. The door lock 300 may include NFC circuitry 316 for enabling the door lock 300 to communicate with other entities via an NFC wireless protocol.

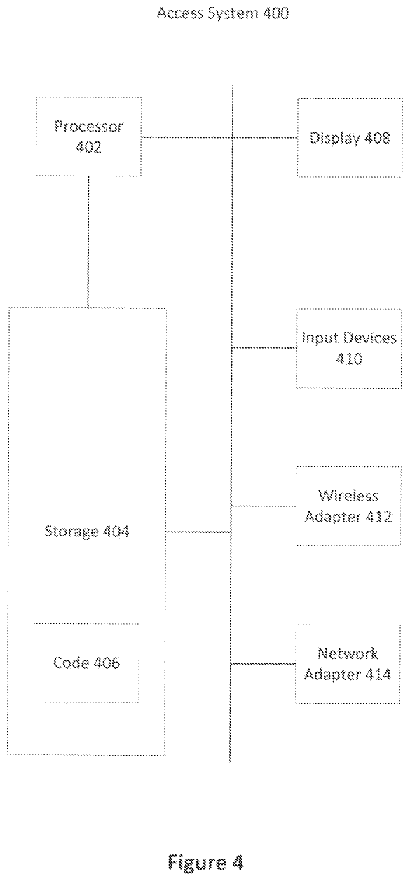

FIG. 4 depicts illustrative components of the access system 400 suitable for exemplary embodiments. The access system 400 may include a processor 402, such as a microprocessor, like a CPU or GPU, a FPGA, an ASIC, or other variety of processor. The access system 400 may include a storage 404. The storage 404 may include primary memory and/or secondary memory and may include non-transitory computer-readable media, like RAM, ROM, solid state memory, magnetic storage media, optical storage media or the like. The storage 404 may store computer programming code 406, which may be executed by the processor 402 to perform operations of the access system 400 as described herein, such as obtaining authentication from the authentication services 112 and 114, obtaining authorization from the authorization service 116, receiving communications from the door locks 104 and 105, sending communications to the door locks 104 and 105, and generally controlling the door locks 104 and 105. The access system 400 may include a display, such as a touchscreen, an LED display, an LCD display, or the like. The access system 400 may include input devices 410, such as a touchscreen, a mouse, a keyboard, a thumbpad, a microphone, etc. The access system 400 may include a wireless adapter 412 for connecting with the wireless network 106 and a network adapter 414 for connecting with a wired network, such as a LAN, like an Ethernet network, or the like. The access system 400 may have Internet access via its wired network connection.

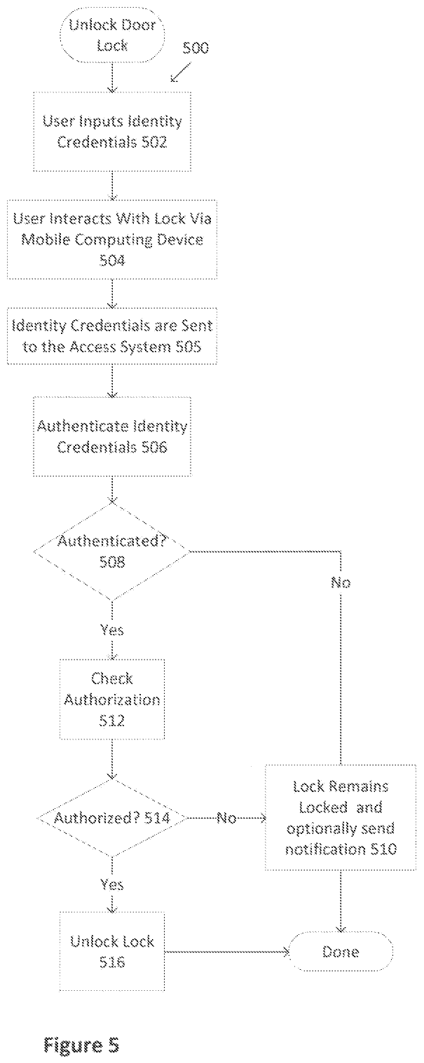

FIG. 5 depicts a flowchart 500 of illustrative steps that may be performed in exemplary embodiments to unlock a lock, such as a door lock. These same operations may more generally apply to unlocking all types of locks in alternative embodiments. Initially, at 502, a user may input identity credentials to the mobile computing device 102, such as by receiving the credentials from a contactless card or typing in the credentials. Different ways of inputting the identity credentials will be detailed below. At 504, the user may interact with a lock, such as door lock 104, using the mobile computing device 102. This may entail approaching the door lock 104 and initiating a wireless NFC session between the mobile computing device 102 and the door lock 104. A communication between the mobile computing device 102 and the door lock 104 may take place to pass the identity credentials from the mobile computing device 102 to the door lock 104. At 505, the identity credentials may be forwarded to the access system 110 via the wireless network 106. At 506, the access system 110 may send the identity credentials to one of the authentication services 112 and 114 to authenticate the identity credentials as authentic. At 508, the authentication services 112 or 114 may return a response indicating, to the access system 110, whether the identity credentials have been deemed authentic or not authentic. If the credentials are not authentic, at 510, the door lock may remain locked. No further action may be taken, or the user may be informed that the attempt to unlock the door lock 104 has failed by receiving feedback via the mobile computing device 102 from the access system 110 or by receiving feedback from the door lock 104, such as a red light on the door lock illuminating. In other embodiments, no such notification may be sent.

Where the authentication indicates that the identity credentials are authenticated, at 514, a check may be made whether the user is authorized to unlock the door lock 104. This may entail the access system 110 sending the identity information to the authorization service 116 and receiving a response. At 514, a check may be made to determine whether the user is authorized. If the user is not authorized, at 510, the door may remain locked. A notification may, in some embodiments, be sent from the access system 110 to the user via the mobile computing device 102 or the door lock 104 indicating that the user is not authorized. In other embodiments, no notification may be sent. Where the user is authorized, the door lock 104 may be unlocked at 516 by the access system 110 sending a message, command, or signal to the door lock 104 that causes the actuator 314 to actuate the locking mechanism 312 to the unlocked position under the control of the processing logic 302.

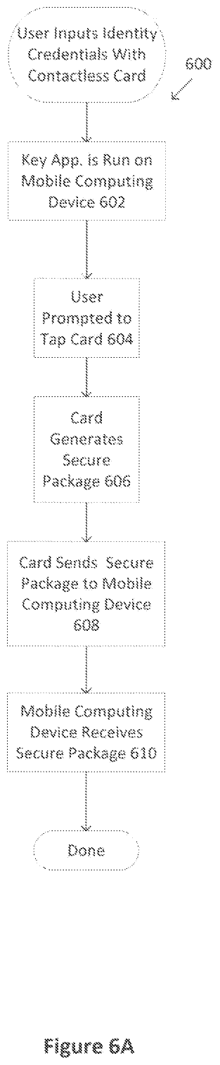

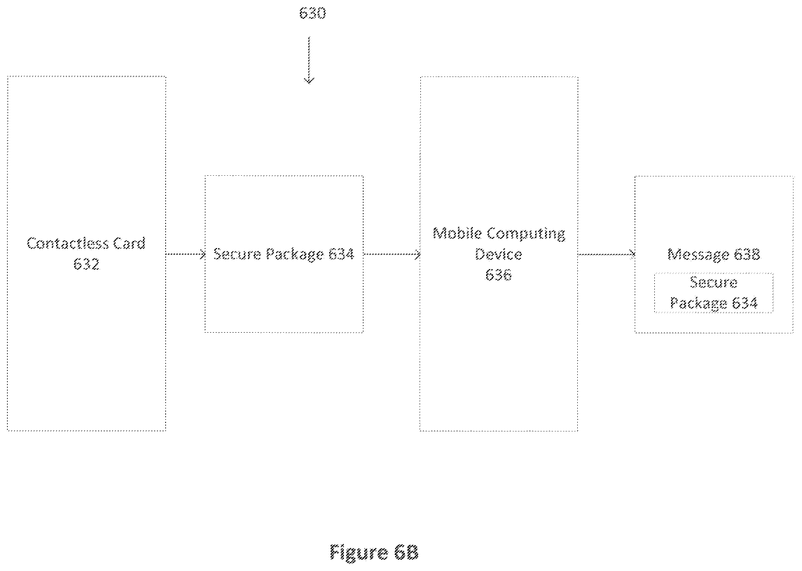

As mentioned above, the identity credentials may be input to the mobile computing device 102 in different manners. FIG. 6A depicts a flowchart 600 which may depict steps that may be performed when the identity credentials are input by way of a contactless card. This flowchart will be described relative to FIG. 6B. Initially, at 602, the key application 210 may be executing on the processor 202 of the mobile computing device 200. At 604, the key application 210 may prompt the user to tap the contactless card 632 to the mobile computing device 636 (or otherwise bring the card 632 within communications range of device 636) to initiate an NFC session between the contactless card 632 and the mobile computing device 636. Doing so may cause the contactless card 632 to transfer identity credentials in a secure package 634 to the mobile computing device 636. The key application 210 may invoke the card application 206 to interact with the contactless card 632. When the contactless card 632 is placed in sufficient proximity with the mobile computing device 636, an NFC session is established.

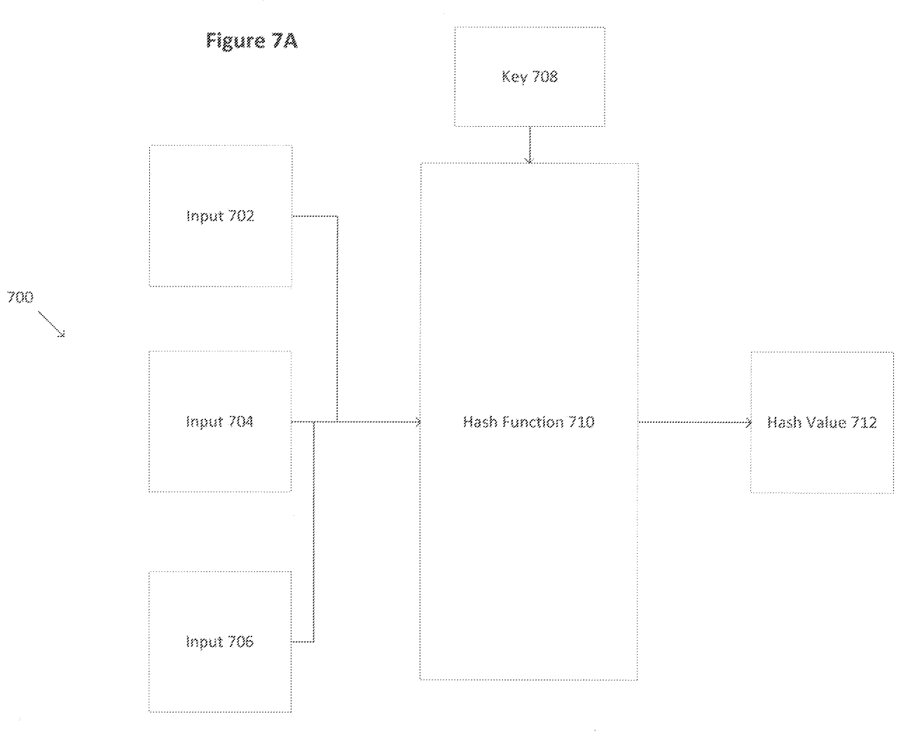

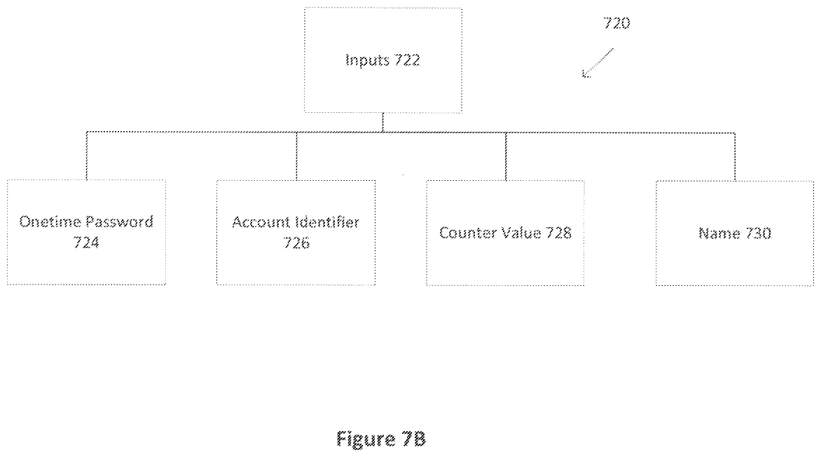

As part of the NFC session, at 606, the contactless card 632 may generate the secure package 634 that may hold the identity credentials. FIG. 7A depicts one example of how the secure package 634 may be generated. The generation of the secure package 634 may employ cryptographic hash functions, such as MD5 or SHA-1. FIG. 7A shows a block diagram 700 depicting how the cryptographic hash functions may be used in exemplary embodiments. In the example shown in FIG. 7A, three inputs 702, 704 and 706 may be passed through a hash function 710 together. The choice of depicting three inputs is intended to be illustrative and not limiting. Other numbers of inputs may be used in some instances. The hash function 710 may produce an output hash value 712. Due to the nature of the hash function 710, it may be computationally difficult to derive the inputs 702, 704 and 706 from the hash value 712 without knowing the key 708 used by the hash function 608. The key 708 may therefore only be stored or otherwise accessible by the contactless card 632 and the authentication service 112.

The key 708 may be dynamically generated for each session and may be particular to the contactless card 632. In some embodiments, the key 708 is generated based on an encryption key stored by the contactless card (e.g., the key 814), where a copy of the key is maintained by the authentication service 112. In some embodiments, the key 708 is dynamically generated for each session by encrypting the key maintained by the card and a counter value maintained by the contactless card to generate a dynamic key 708. The dynamic key 708 may then be used for the hash function 608. Thus, the hash function 710 may provide a layer of security for the content (e.g., inputs 702, 704 and 706) that may be included in the secure package 634.

In the exemplary embodiments, the inputs 702, 704 and 706 may vary depending on the information the parties agree to exchange and/or the agreed protocol for authenticating the initiating party. FIG. 7B, shows a diagram 720 of possible types of inputs 722 that may be hashed in exemplary embodiments. The inputs 722 may be agreed upon by the contactless card 632 and the authentication service 112. In these exemplary embodiments, a one-time password 724 generated by the contactless card 632 may be included as an input. An account identifier 726 for the initiating party may be provided as an input. This may be an account number or other identifier that uniquely identifies the account of the initiating party. As was described above, the account identifier 726 may be a phone number for the initiating party. The inputs 722 may include a counter value 728 maintained by the contactless card 632. In some embodiments, the counter value 728 is synchronized with the authorization service 116 and/or the authentication services 112, 114. The inputs 722 may include a name 730 of the initiating party. As an added layer of security, the hash value 712 may be encrypted in some embodiments.

With reference again to FIG. 6, at 608, the contactless card 632 may send the secure package 634 to the mobile computing device 636. The mobile computing device 636 may receive the secure package at 610. As shown in FIG. 6B, the secure package 634 may then ultimately be included in a message 638 that may be sent from the mobile computing device 636 to the access system over the wireless network (see step 506 in FIG. 5). The access system may then provide the message 638 to the authentication service 112 for authentication. To verify authenticate the hash value 712 generated by the contactless card, the authentication service 112 may recreate the hash value 712 using the agreed-upon inputs 722. The authentication service 112 may then compare the recreated hash value 712 to the hash value in the secure package 634 (which may be decrypted if encrypted). If the comparison results in a match, the authentication service 112 authenticates the secure package 634 and transmits an indication of the authentication to the access system 110 and/or the authorization service 116. If the comparison does not result in a match, the authentication service 112 does not authenticate the secure package 634 and transmits an indication of the failed authentication to the access system 110 and/or the authorization service 116. Doing so may cause the access system 110 and/or the authorization service 116 to reject a requested unlocking of a door lock or any other lock.

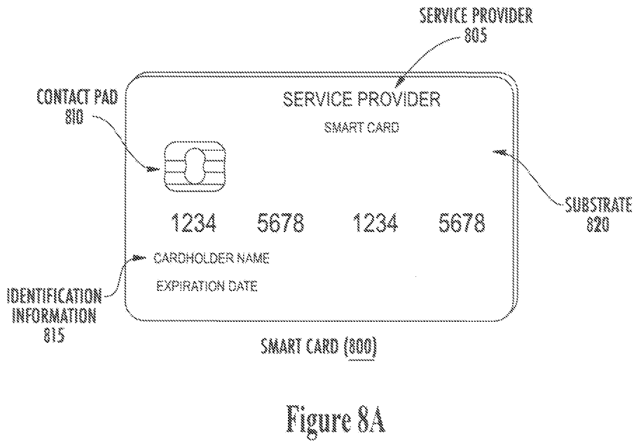

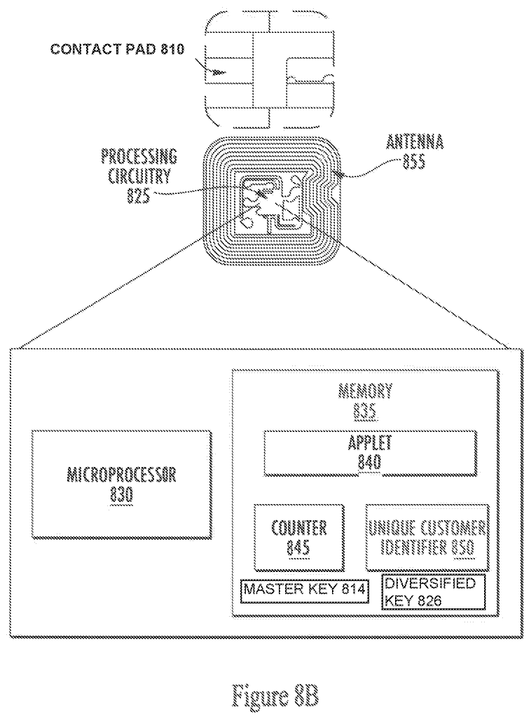

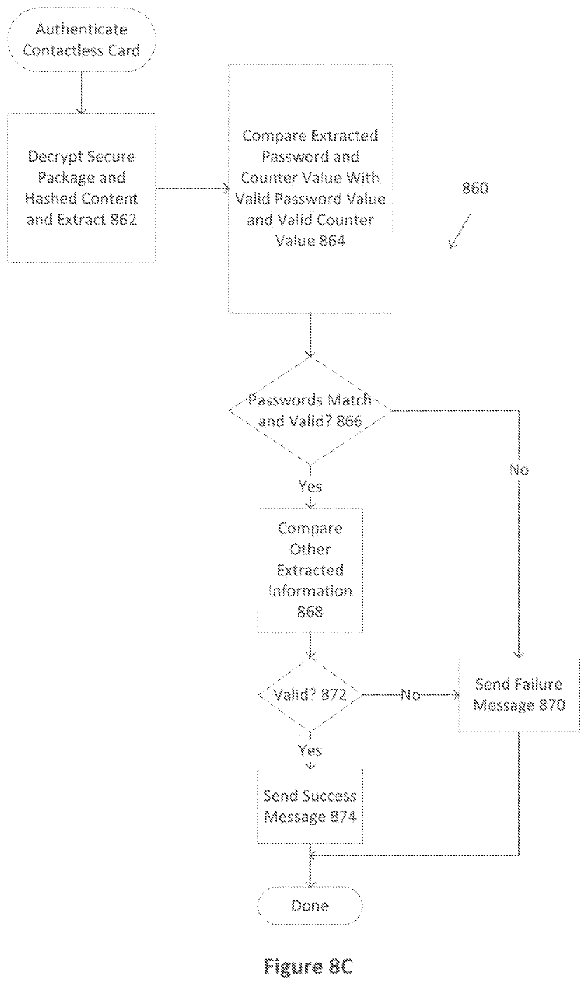

FIG. 8A illustrates an exemplary contactless card 800 that may be used in exemplary embodiments. The contactless card 800 may be a payment card, such as a credit card, a debit card, or a gift card, issued by a service provider 805 displayed on the front or back of the card 800. In some exemplary embodiments, the contactless card 800 is not related to a payment card, and may comprise, without limitation, an identification card. In some instances, the payment card may comprise a dual interface contactless payment card. The contactless card 800 may comprise a substrate 820, which may include a single layer or laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 800 may have physical characteristics compliant with the ID-1 format of the ISO/IEC 7810 standard, and the contactless card 800 may otherwise be compliant with the ISO/IEC 14443 standard. However, it is understood that the contactless card 800 according to the present disclosure may have different characteristics, and the present disclosure does not require a contactless card to be implemented in a payment card.

The contactless card 800 may also include identification information 815 displayed on the front and/or back of the card, and a contact pad 810. The contact pad 810 may be configured to establish communications with another communication device, such as a user device, smart phone, laptop, desktop, or tablet computer. The contactless card 800 may also include processing circuitry, antenna and other components not shown in FIG. 8A. These components may be located behind the contact pad 810 or elsewhere on the substrate 820. The contactless card 800 may also include a magnetic strip or tape, which may be located on the back of the card (not shown in FIG. 8A).

As illustrated in FIG. 8B, the contact pad 810 of FIG. 8A may include processing circuitry 825 for storing and processing information, including a microprocessor 830 and a memory 835. It is understood that the processing circuitry 825 may contain additional components, including processors, memories, error and parity (e.g., cyclic redundancy check (CRC)) checkers, data encoders, anti-collision algorithms, controllers, command decoders, security primitives and tamper proofing hardware, as necessary to perform the functions described herein.

The memory 835 may be a read-only memory, write-once read-multiple memory or read/write memory, e.g., RAM, ROM, and EEPROM, and the contactless card 800 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. It may also be read many times.

The memory 835 may be configured to store one or more applets 840, a master key 814, a diversified key 826, one or more counters 845, and a customer identifier 850. Generally, a server (such as the authentication service 112) and the contactless card 800 may be provisioned with the same master key 814 (also referred to as a master symmetric key). More specifically, each contactless card 800 is programmed with a distinct master key 814 that has a corresponding pair maintained by the server. For example, when a contactless card 800 is manufactured, a unique master key 814 may be programmed into the memory 838 of the contactless card 800. Similarly, the unique master key 814 may be stored by the server (e.g., in a hardware security module).

Furthermore, when a given card 800 is manufactured, a diversified key 826 may be diversified from the master key 814 via function that takes, as input, a diversification factor and the master key 814. In some embodiments, the diversification factor may be the counter 845 of the contactless card 800. The diversified key 826 may be stored in the contactless card 800 and the server. The master key 814 and diversified key 826 may be kept secret from all parties other than the contactless card 800 and server, thereby enhancing security. Furthermore, as described below, the value of the counter 845 may change over time. As such, the diversified key 826 may change as well.

The one or more applets 840 may comprise one or more software applications configured to execute on one or more contactless cards, such as Java Card applet. However, it is understood that applets 840 are not limited to Java Card applets, and instead may be any software application operable on contactless cards or other devices having limited memory. The one or more counters 845 may comprise a numeric counter sufficient to store an integer. The counters 845 may correspond to the counter 728 of FIG. 7B. The counters 845 may be synchronized with a server, such as the authorization service 116 and/or the authentication services 112, 114. Each time a read operation takes place, the counter 845 may be configured to increment. In some examples, each time data from the contactless card is read (e.g., by a mobile device), the counter 845 is transmitted to the server for validation and determines whether the counter 845 is equal to an instance of the counter 845 maintained by the server (and/or are within a threshold amount). Therefore, when data is received from the card, the server may increment the instance of the counter 845 maintained by the server. As another example, when the mobile device reads data from the contactless card, the mobile device may inform the server of the read, which may cause the server to increment the instance of the counter 845 maintained by the server.

In some embodiments, the counter 845 may be included in a cryptographic payload generated by the contactless card 800 and included in cleartext with the cryptographic package. The cryptographic payload may comprise a one-time password (OTP). In such embodiments, the server may recreate the diversified key 826 based on an instance of the master key 814 and an instance of the counter 845 maintained by the server. The server may then decrypt the cryptographic payload using the diversified key 826, which may produce the counter value. The server may then compare the decrypted counter value 845 with the unencrypted counter 845 to validate or authenticate the cryptographic payload.

The customer identifier 850 may comprise a unique alphanumeric identifier assigned to a user of the contactless card 800, and the identifier may distinguish the user of the contactless card from other contactless card users. In some examples, the customer identifier 850 may identify both a customer and an account assigned to that customer and may further identify the contactless card associated with the customer's account.

The processor and memory elements of the foregoing exemplary embodiments are described with reference to the contact pad, but the present disclosure is not limited thereto. It is understood that these elements may be implemented outside of the pad 810 or entirely separate from it, or as further elements in addition to processor 830 and memory 835 elements located within the contact pad 810.

In some examples, the contactless card 800 may comprise one or more antennas 855. The one or more antennas 855 may be placed within the contactless card 800 and around the processing circuitry 825 of the contact pad 810. For example, the one or more antennas 855 may be integral with the processing circuitry 825 and the one or more antennas 855 may be used with an external booster coil. As another example, the one or more antennas 855 may be external to the contact pad 810 and the processing circuitry 825.

In an embodiment, the coil of contactless card 800 may act as the secondary of an air core transformer. The terminal may communicate with the contactless card 800 by cutting power or amplitude modulation. The contactless card 800 may infer the data transmitted from the terminal using the gaps in the contactless card's power connection, which may be functionally maintained through one or more capacitors. The contactless card 800 may communicate back by switching a load on the contactless card's coil or load modulation. Load modulation may be detected in the terminal's coil through interference.

As explained above, the contactless card 800 may be built on a software platform operable on smart cards or other devices having limited memory, such as JavaCard, and one or more applications or applets may be securely executed. Applets may be added to contactless cards to provide an OTP for multifactor authentication (MFA) in various mobile application-based use cases. Applets may be configured to respond to one or more requests, such as near field data exchange requests, from a reader, such as a mobile NFC reader, and produce an NFC Data Exchange Format (NDEF) message that comprises a cryptographically secure OTP encoded as an NDEF text tag. One example of an NDEF OTP is an NDEF short-record layout (SR=1). In such an example, the one or more applets 840 may be configured to encode the OTP as an NDEF type 4 well known type text tag. In some examples, NDEF messages may comprise one or more records.

FIG. 8C depicts a flowchart 860 of steps that may be performed by the authentication service 112 when a contactless card 800 is used. Initially, at 862 the authentication service 112 may use decryption keys to decrypt the secure package 634. As stated, the authentication service 112 may recreate the decryption keys to decrypt the secure package, e.g., by encrypting the master key 814 and the counter value 845 to generate the diversified key 826. In addition, the decryption keys may be used to decrypt the hash value 712 to extract the inputs that were hashed together by the hash function 710. In some embodiments, the authentication service 112 recreates the hash value using the same inputs used by the contactless card and compares the recreated hash value to the decrypted hash value to verify the hash value. At 864, the extracted password 724 and counter value 728 may be compared with a valid password and a valid counter value (e.g., valid passwords and counter values stored by the authentication service 112 in a database). At 866, a determination may be made whether the passwords match and the counter values match or if the extracted counter value otherwise indicates that the password has not expired. For example, if the extracted counter value does not equal (or is not within a threshold value) of the valid counter values, the authentication service 112 may determine the password has expired. At 868, if the passwords match and the extracted password has not expired based on the extracted counter value, other extracted information may be compared. At 872, if the other information is valid based on the comparison, then, at 874, the user's identity may be authenticated, and a success message may be returned to the access system 110. If not, at 870, the user's identity is not authenticated, and a failure message may be sent to the access system 110. Similarly, at 870, if the passwords do not match or the password has expired as indicated by the extracted counter value, the initiating party is not authenticated, and a failure message may be sent.

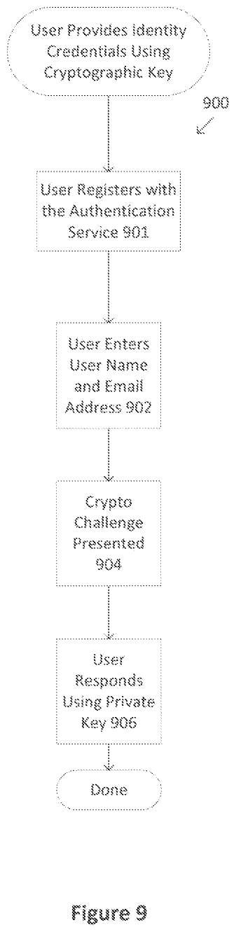

The identity credentials may also be provided using a cryptographic key. FIG. 9 depicts a flowchart 900 depicting illustrative steps that may be performed in exemplary embodiments when such an approach to providing identity credentials is used. Initially, at 901, the user may register with the authentication service 112 or 114, such as a FIDO2 authentication service. This may include providing a name, email address, and choosing a password. Other personal information may also be provided. Once registered, the user may be provided with a private cryptographic key from the authentication service 112 or 114. The registration may be completed as a separate transaction before the user seeks to open the door lock 104. When the user wishes to unlock the door lock, at 902 the user may access a web page using web browser 207 or invokes the key application 210 on the mobile computing device, where the user is prompted to enter an email address and password. If the correct email address and password are provided, at 904 a cryptographic challenge may be presented that seeks a response. The correct response may require access to the private cryptographic key. At 906, the user may generate the response using the private key and send the response to the authentication service 112 or 114.

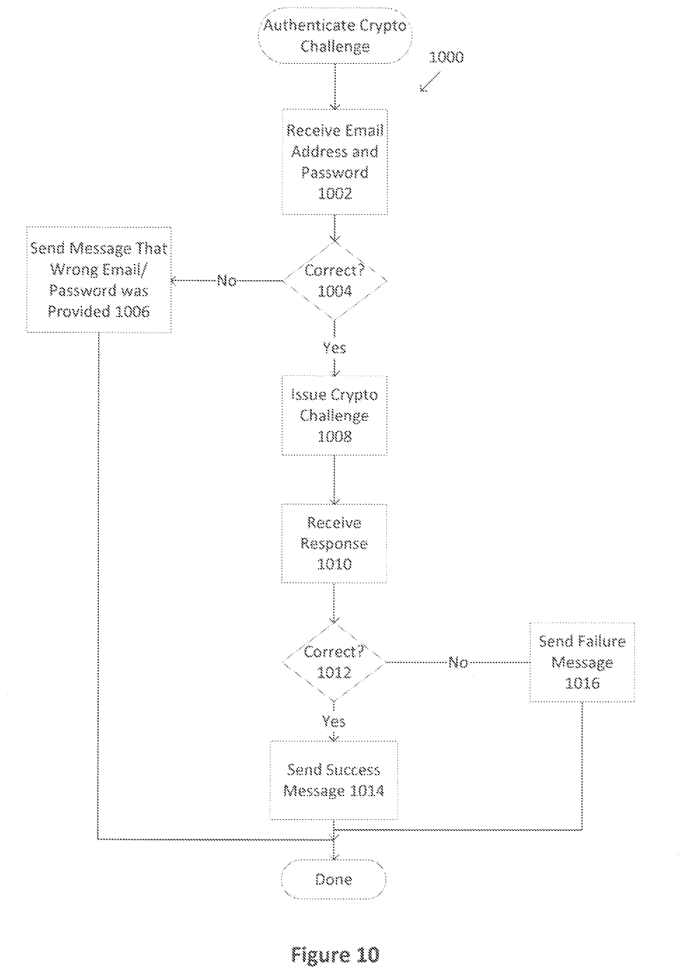

FIG. 10 depicts a flowchart 1000 showing illustrative steps that may be performed in authenticating the user with a crypto challenge by the authentication service 112 or 114. At 1002, the authentication service 112 or 114 may receive the email address and password from the user as described above. At 1004, the authentication service 112 or 114 may determine whether the email address is for a registered user and may determine that the received password matches a registered password for the user. If the email address is not for a registered user or the password does not match the registered password, at 1006 a message may be sent to the mobile computing device 102 of the user indicating that at least one of a wrong email address or password was provided and the authentication may cease. If the proper email address and password were provided, at 1008 the authentication service 112 or 114 may issue a cryptographic challenge that requires the user to be in possession of the private key that was issued to use upon registration. A number of different cryptographic challenge approaches may be adopted, such as that used with the FIDO2 authentication protocol. At 1010, a response may be received at the authentication service 112 or 114 from the mobile computing device 102 of the user. At 1012, the authentication service determines whether the response was correct. At 1014, if the response is correct, a success message may be sent. If the response is not correct, at 1016 a failure message may be sent.

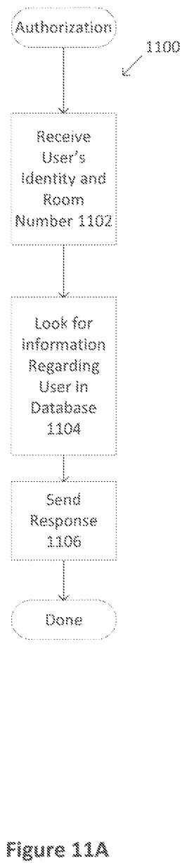

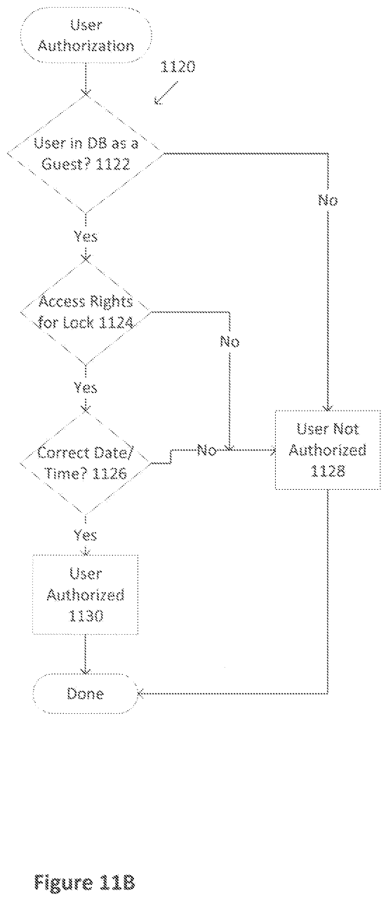

FIG. 11A depicts a flowchart 1100 showing illustrative steps that may be performed by the authorization service 116 in processing a user request to unlock a lock, such as a door lock. At 1102, the authorization service 116, may receive the user's identity (e.g., name) and the room number of the guest room. At 1104, the database 118 may be accessed to determine for information regarding the guest. The database 118 may hold a list of all current guests, what room numbers they may access and over what dates and times they may access the room(s). In addition, the database 118 may hold access rights for the guest that may be used to determine what locks the guest may unlock. Based upon what is in the database 118, at 1106, a response may be generated by the authorization service 116 and sent to the access system 110. The response may contain the information for the guest that was retrieved from the database 118 in some embodiments or may indicate an absence of information in the database for the guest. Alternatively, the authorization service 116 may process the data to determine whether the user is authorized or not to unlock the lock, such as the door lock 104 for the specified guest room. In some embodiments, the access system 110 processes the data to determine whether the user may unlock a door.

FIG. 11B depicts a flowchart 1120 showing illustrative steps that may be performed by the access system 110 or the authorization service 116 to determine whether the user is authorized to unlock the lock, such as door lock 104, based on information retrieved from the database 118. At 1122, a determination may be made as to whether the user is a registered guest. If the user is not a registered guest, at 1128, the user may be deemed to be not authorized. If the user is registered as a guest, at 1124, a determination may be made as to whether the user possesses access rights to unlock the specified lock. If the user does not have access rights, at 1128, the user may be deemed to be not authorized. If the user has access rights, at 1126, a date/time check may be made to determine if the user is currently authorized to unlock the lock. If the user is currently authorized, the user may be deemed to be authorized to unlock the lock, and an unlock instruction may be sent to the lock. If the user is not authorized, at 1128, the unlock instruction may not be sent to the lock.

While the present disclosure has been described with reference to exemplary embodiments herein, it will be appreciated that various changes in scope and detail may be made without departing from the intended scope as defined in the appended claims.

1. A method performed by a processor of a computing device to wirelessly control a door lock using an authentication service and an authorization service and based on a contactless card of a user, the method comprising:
receiving, from the door lock and over a wireless network, a secure package comprising a cryptographic payload, the cryptographic payload generated by the contactless card based at least in part on a cryptographic key for the contactless card, wherein the door lock is of a door to a specified area, wherein the secure package is received in a specified time period;
transmitting the cryptographic payload to the authentication service for authentication based at least in part on an instance of the cryptographic key for the contactless card maintained by the authentication service, wherein the authentication service has registered the user;
receiving a response from the authentication service indicating that the cryptographic payload was authenticated based at least in part on the instance of the cryptographic key for the contactless card maintained by the authentication service;
determining, by the authorization service and based on access information, that the user is authorized to unlock the door lock of the door to the specified area in the specified time period; and
sending a communication over the wireless network to the door lock to cause the door lock to unlock.

2. The method of claim 1, wherein the cryptographic key comprises a diversified key, wherein the diversified key is generated by the contactless card and the authentication service based on a master key and a counter value for the contactless card.

3. The method of claim 2, wherein the counter value is synchronized between the contactless card and the authentication service.

4. The method of claim 1, wherein the cryptographic payload comprises a hash value, wherein the hash value is generated based at least in part on a hash function and the cryptographic key.

5. The method of claim 4, wherein the hash value is further generated based at least in part on a one-time password (OTP) generated by the contactless card, a counter value maintained by the contactless card, and an account identifier stored by the contactless card.

6. The method of claim 5, wherein the authentication service authenticates the cryptographic payload based at least in part on:
generating an instance of the hash value based on the OTP, the counter value, and the account identifier; and
determining, based on a comparison, that the instance of the hash value matches the hash value of the cryptographic payload;
wherein the access information is stored in a database, and wherein the authorization service is configured to:
upon determining that the user is unrecognized by the authorization service despite the user having been authenticated, deny a request from the user to unlock the door lock;
upon determining that the user is recognized by the authorization service but that the user is not authorized to unlock the door in any time period, deny a request from the user to unlock the door lock;
upon determining that the user is authorized to unlock the door but only in a time period other than the specified time period, deny a request from the user to unlock the door lock;
upon receiving, from the authentication service, an indication that the authentication service has not registered the user, deny a request from the user to unlock the door lock; and
upon receiving, from the authentication service, an indication that the authentication service has registered the user but failed to authenticate the user, deny a request from the user to unlock the door lock.

7. The method of claim 1, wherein the wireless network is an Institute of Electrical and Electronics Engineers (IEEE) 802.11ah network.

8. A method performed by a processor of a computing device to wirelessly control a door lock using an authentication service and an authorization service and based on a contactless card of a user, the method comprising:
receiving, from the door lock and over a wireless network, a secure package comprising a cryptographic payload, the cryptographic payload generated by the contactless card based at least in part on a cryptographic key for the contactless card, wherein the door lock is of a door to a specified area, wherein the secure package is received in a specified time period;
transmitting the cryptographic payload to the authentication service for authentication based at least in part on an instance of the cryptographic key for the contactless card maintained by the authentication service, wherein the authentication service has registered the user;
receiving a response from the authentication service indicating that the cryptographic payload was not authenticated based at least in part on the instance of the cryptographic key for the contactless card maintained by the authentication service;
determining, by the authorization service and based on the response from the authentication service, that the user is not authorized to unlock the door lock of the door to the specified area in the specified time period; and
sending, to a mobile device associated with the user, an indication specifying that the user is not authorized to unlock the door lock.

9. The method of claim 8, wherein the cryptographic key comprises a diversified key, wherein the diversified key is generated by the contactless card and the authentication service based on a master key and a counter value for the contactless card.

10. The method of claim 9, wherein the counter value is synchronized between the contactless card and the authentication service.

11. The method of claim 8, wherein the cryptographic payload comprises a hash value, wherein the hash value is generated based at least in part on a hash function and the cryptographic key.

12. The method of claim 11, wherein the hash value is further generated based at least in part on a one-time password (OTP) generated by the contactless card, a counter value maintained by the contactless card, and an account identifier stored by the contactless card.

13. The method of claim 12, wherein the authentication service authenticates the cryptographic payload based at least in part on:
generating an instance of the hash value based on the OTP, the counter value, and the account identifier; and
determining, based on a comparison, that the instance of the hash value does not match the hash value of the cryptographic payload.

14. The method of claim 8, wherein the wireless network is an Institute of Electrical and Electronics Engineers (IEEE) 802.11ah network.

15. A method performed by processing logic of a door lock to control the door lock using an authentication service and an authorization service and based on a contactless card of a user, the door lock being of a door to a specified area, the method comprising:
receiving, from the contactless card and in a specified time period, a secure package comprising a cryptographic payload, the cryptographic payload generated based at least in part on a cryptographic key for the contactless card;
transmitting, via a wireless network, the cryptographic payload to the authentication service for authentication based at least in part on an instance of the cryptographic key for the contactless card maintained by the authentication service;
receiving a response from the authentication service indicating that the cryptographic payload was authenticated based at least in part on the instance of the cryptographic key for the contactless card maintained by the authentication service;
sending a communication to the authorization service to determine whether the user is authorized to unlock the door lock of the door to the specified area in the specified time period;
receiving, from the authorization service, an indication specifying that the user is authorized to unlock the door lock of the door to the specified area at the specified time period; and
unlocking the door lock based on the responses received from the authentication service and the authorization service.

16. The method of claim 15, wherein the cryptographic key comprises a diversified key, wherein the diversified key is generated by the contactless card based on a master key and a counter value for the contactless card.

17. The method of claim 16, wherein the counter value is synchronized between the contactless card and the authentication service.

18. The method of claim 15, wherein the cryptographic payload comprises a hash value, wherein the hash value is generated based at least in part on a hash function and the cryptographic key.

19. The method of claim 18, wherein the hash value is further generated based at least in part on a one-time password (OTP) generated by the contactless card, a counter value maintained by the contactless card, and an account identifier stored by the contactless card.

20. The method of claim 15, wherein the wireless network is an Institute of Electrical and Electronics Engineers (IEEE) 802.11ah network.
